(19) United States
(12) Patent Application Publication
(10) Pub. No.: US 2022/0264512 A1
(43) Pub. Date: Aug. 18, 2022

(54) CONTROLLER, COMMUNICATION APPARATUS, COMMUNICATION SYSTEM, CONTROL CIRCUIT, STORAGE MEDIUM, AND COMMUNICATION METHOD

(71) Applicant: Mitsubishi Electric Corporation, Tokyo (JP)

(72) Inventor: Jun MIZUGUCHI, Tokyo (JP)

(73) Assignee: Mitsubishi Electric Corporation, Tokyo (JP)

(21) Appl. No.: 17/738,578

(22) Filed: May 6, 2022

Related U.S. Application Data
(63) Continuation of application No. PCT/JP2020/001984, filed on Jan. 21, 2020.

(51) Int. Cl. H04W 60/04; H04W 76/12; H04W 28/02

(52) U.S. Cl. CPC H04W 60/04; H04W 28/0268; H04W 76/12

(57) ABSTRACT

A controller for controlling transfer of communication data performed by a first communication apparatus includes: a flow-bearer conversion table in which identification information on the first communication apparatus and transfer operation information are registered in association with each other, the transfer operation information indicating details of transfer processing of communication data in the first communication apparatus; a session management unit extracting the identification information on the first communication apparatus and resource information from control data received from a second communication apparatus, the resource information being allocated by the second communication apparatus to a wireless terminal; and a table control unit registering, in the flow-bearer conversion table, the identification information on the first communication apparatus and the transfer operation information in association with each other, the identification information on the first communication apparatus being extracted by the session management unit, the transfer operation information being based on the resource information.

### CROSS-REFERENCE TO RELATED APPLICATION

This application is a continuation application of International Application PCT/JP2020/001984, filed on Jan. 21, 2020, and designating the U.S., the entire contents of which are incorporated herein by reference.

### BACKGROUND OF THE INVENTION

### 1. Field of the Invention

The present disclosure relates to a controller, a communication apparatus, a communication system, a control circuit, a storage medium, and a communication method to be used between networks using different routing protocols.

### 2. Description of the Related Art

In a conventional communication system for a heterogeneous network including networks using different routing protocols, such as a wireless network and a wired network, another network using a dedicated line has been configured so as to ensure the quality of service (QoS) in terms of, for example, an end-to-end band and delay time. Meanwhile, “OpenFlow Switch Specification Ver 1.5.1, ONF TS-025, Mar. 26, 2015 (https://www.opennetworking.org/wp-content/uploads/2014/10/OpenFlow-switch-v1.5.1.pdf)” of Non Patent Literature 1, discloses, as means for achieving flexible QoS control, a technique regarding OpenFlow that implements a network with software.

Distinction between layers up to Layer 4 of an Open System Interconnection (OSI) reference model, such as the Transmission Control Protocol (TCP) and the User Datagram Protocol (UDP), is defined in OpenFlow described in Non Patent Literature 1 described above. In contrast, Japanese Patent No. 6092873 discloses a technique for achieving load balance of a server by extending identification items up to a Tunnel Endpoint Identifier (TEID) of a GTP-U header included in a frame for transferring user data in the General Packet Radio Service (GPRS) Tunneling Protocol (GTP) of Layer 5 while using OpenFlow.

However, in a case where local networks are separately constructed, such as a wireless network and a wired network, there is a problem in that a network configuration cannot be changed promptly. This is because the cost for constructing each network becomes high, and in addition, it is necessary to perform design, change, and the like in advance in changing a new communication apparatus for the local network. In Japanese Patent No. 6092873, while it is possible to identify session of a wireless network, there is no mention of resource control such as QoS, and in addition, no consideration is given to cooperation with other networks.

### SUMMARY OF THE INVENTION

In order to solve the above-described problems and achieve the object, the present disclosure is a controller to control transfer of communication data in a communication system including a wired network and a wireless network, the transfer of communication data being performed by a first communication apparatus included in each of the wired network and the wireless network. The controller includes: a table in which identification information on the first communication apparatus and transfer operation information are registered in association with each other, the transfer operation information indicating details of transfer processing of communication data in the first communication apparatus; a session management unit to extract the identification information on the first communication apparatus and resource information from control data received from a second communication apparatus connected to the first communication apparatus, the resource information being allocated by the second communication apparatus to a wireless terminal to be connected to the first communication apparatus of the wireless network; and a table control unit to register, in the table, the identification information on the first communication apparatus and the transfer operation information in association with each other, the identification information on the first communication apparatus being extracted by the session management unit, the transfer operation information being based on the resource information.

### BRIEF DESCRIPTION OF THE DRAWINGS

FIG. 1 is a diagram illustrating an example configuration of a communication system according to a present embodiment;

FIG. 2 is a diagram illustrating an example configuration of a controller according to the present embodiment;

FIG. 3 is a diagram illustrating an example configuration of OpenFlow switches according to the present embodiment;

FIG. 4 is a sequence diagram illustrating a process in which the communication system according to the present embodiment establishes communication with a wireless terminal;

FIG. 5 is a diagram illustrating relationships between a flow-bearer conversion table included in the controller and flow tables included in the OpenFlow switches according to the present embodiment;

FIG. 6 is a flowchart illustrating operation of the controller according to the present embodiment;

FIG. 7 is a flowchart illustrating operation of the OpenFlow switch according to the present embodiment;

FIG. 8 is a flowchart illustrating operation of a 5G Core according to the present embodiment;

FIG. 9 is a diagram illustrating an example configuration of processing circuitry in a case where the processing circuitry included in the controller according to the present embodiment is implemented by a processor and a memory; and

FIG. 10 is a diagram illustrating an example of processing circuitry in a case where the processing circuitry included in the controller according to the present embodiment includes dedicated hardware.

### DETAILED DESCRIPTION OF THE PREFERRED EMBODIMENTS

Hereinafter, a controller, a communication apparatus, a communication system, a control circuit, a storage medium, and a communication method according to an embodiment of the present disclosure will be described in detail with reference to the drawings. Note that the present disclosure is not limited to the embodiment. A fifth generation mobile communication system in the 3rd Generation Partnership Project (3GPP) will be assumed and described in the present embodiment. Meanwhile, the present embodiment is also applicable to a fourth generation mobile communication system. Furthermore, in the present embodiment, a layer refers to a layer defined in an OSI reference model.

### Embodiment

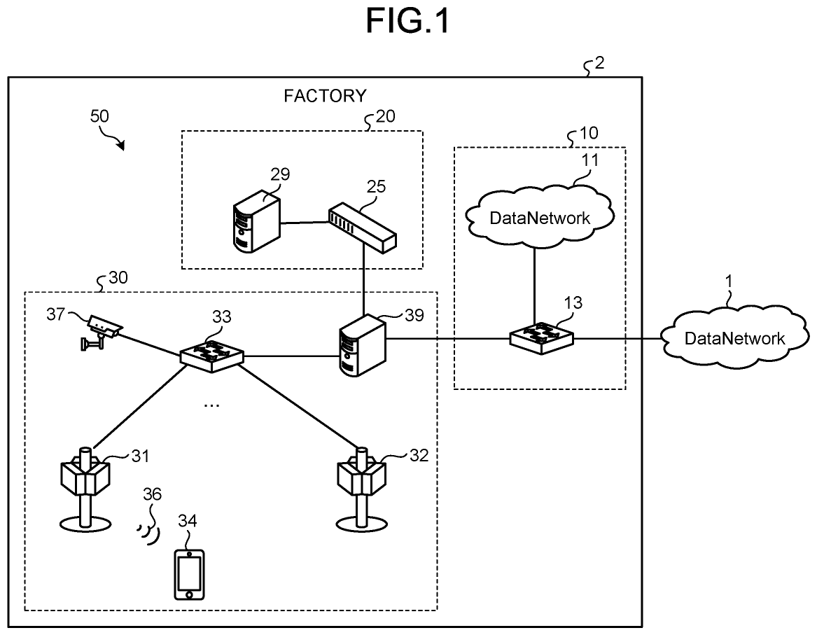

FIG. 1 is a diagram illustrating an example configuration of a communication system 50 according to a present embodiment. The communication system 50 is a communication system for a heterogeneous network including a wireless network 30 using local 5G and a wired network 10 using Ethernet (registered trademark) in a factory 2. The factory 2 is connected to DataNetwork 1. The DataNetwork 1 is a network external to the factory 2, and is a network connected to the Internet. The communication system 50 which is an internal network of the factory 2 includes three networks of the wired network 10, a wired network 20, and the wireless network 30. Note that a case where the communication system 50 is installed in the factory 2 will be specifically described as an example in the present embodiment, but a place where the communication system 50 is installed is not limited to the factory 2. Furthermore, in the communication system 50, the number of the wired networks 10 and the number of the wireless networks 30 are not limited to one.

The wired network 10 is a local network provided inside the factory 2. The wired network 10 includes DataNetwork 11 and an OpenFlow switch 13. The DataNetwork 11 is a local data network provided inside the factory 2. The OpenFlow switch 13 is a communication apparatus included in the wired network 10 in the communication system 50 including the wired network 10 and the wireless network 30. The OpenFlow switch 13 connects the wireless network 30 and the DataNetwork 1, and controls communication between the wireless network 30 and the DataNetwork 1. The configuration and operation of the OpenFlow switch 13 will be described in detail later. In the following description, the OpenFlow switch 13 may be referred to as a first communication apparatus or simply as a communication apparatus.

The wired network 20 is a local network that manages each local network within the factory 2. The wired network 20 includes a communication hub 25 and a controller 29. The communication hub 25 connects the controller 29 and the wireless network 30, and controls communication between the controller 29 and the wireless network 30. The controller 29 controls communication in the communication system 50 which is an internal network of the factory 2. Specifically, the controller 29 controls transfer of communication data in the communication system 50 including the wired network 10 and the wireless network 30. The transfer of communication data is performed by an OpenFlow switch included in each of the wired network 10 and the wireless network 30. The configuration and operation of the controller 29 will be described in detail later.

The wireless network 30 is a local network provided inside the factory 2. The wireless network 30 includes antennas 31 and 32, an OpenFlow switch 33, a camera 37, and a 5G core 39. Each of the antennas 31 and 32 is connected to a wireless terminal 34 by use of a radio signal 36, and outputs the radio signal 36 received from the wireless terminal 34 to the OpenFlow switch 33. FIG. 1 shows an example in which the antenna 31 is connected to the wireless terminal 34 by use of the radio signal 36. The OpenFlow switch 33 is a communication apparatus included in the wireless network 30 in the communication system 50 including the wired network 10 and the wireless network 30. The OpenFlow switch 33 is connected to the antennas 31 and 32, the camera 37, and the 5G core 39. The OpenFlow switch 33 performs control so as to transfer, to the 5G core 39, the radio signal 36 acquired from the wireless terminal 34 via the antenna 31 or the antenna 32 and moving image data acquired from the camera 37. The configuration and operation of the OpenFlow switch 33 will be described in detail later. In the following description, the OpenFlow switch 33 may be referred to as a first communication apparatus or simply as a communication apparatus. In addition, the 5G core 39 may be referred to as a second communication apparatus.

In the wireless network 30, the camera 37 captures a moving image of the inside of the factory 2, and outputs, to the OpenFlow switch 33, moving image data obtained as a result of the capturing. The 5G core 39 connects networks that use different routing protocols. The 5G core 39 serves a U-plane function between the OpenFlow switches 13 and 33 as well as a C-plane function in local 5G. The C-plane function is the function of establishing a session or the like between devices. The U-plane function is the function of transferring the radio signal 36 acquired from the wireless terminal 34 via the antenna 31 or the antenna 32 and moving image data acquired from the camera 37.

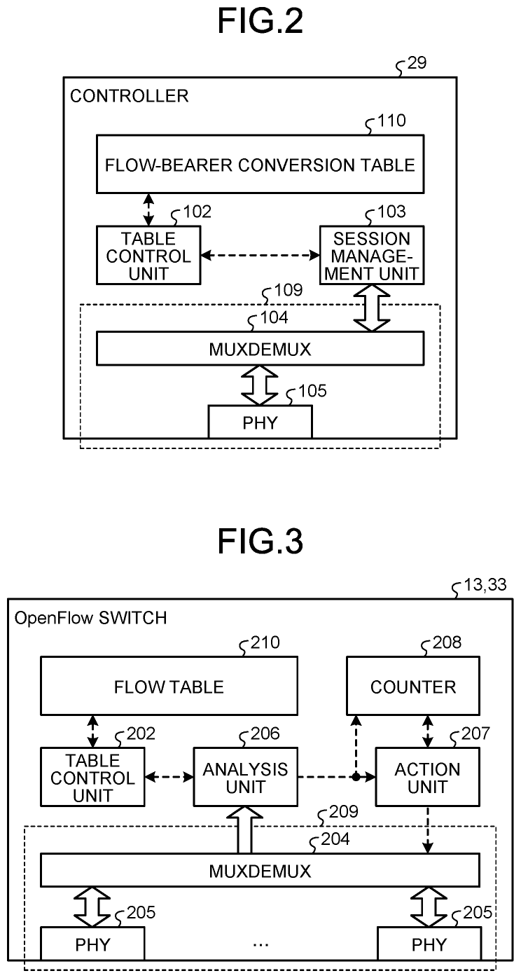

Next, the configuration and operation of the controller 29 will be described. FIG. 2 is a diagram illustrating an example configuration of the controller 29 according to the present embodiment. The controller 29 includes a table control unit 102, a session management unit 103, a MUXDEMUX 104, a PHY 105, and a flow-bearer conversion table 110.

The PHY 105 is connected to the communication hub 25, and transmits and receives control data to and from the 5G core 39.

The MUXDEMUX 104 handles transfer of control data in the direction of transmission and the direction of reception as viewed from the controller 29. Specifically, the MUXDEMUX 104 transfers control data from the session management unit 103 to the PHY 105 at the time of transmission, and transfers control data from the PHY 105 to the session management unit 103 at the time of reception. The MUXDEMUX 104 and the PHY 105 are collectively referred to as a communication unit 109. As described above, the MUXDEMUX 104 and the PHY 105, that is, the communication unit 109 receives control data from the 5G core 39, and transmits transfer operation information obtained by the table control unit 102 to the OpenFlow switches 13 and 33 via the 5G core 39.

The session management unit 103 extracts identification information from the received control data. Specifically, upon receiving control data for the wireless network 30, the session management unit 103 extracts, as identification information, a QoS flow ID (QFI) in a GTP-U header. As described above, in the present embodiment, a QFI regarding service quality contained in the header of a frame to be used for data transfer to be performed by use of GTP-U is used as identification information on the OpenFlow switch 33 included in the wireless network 30. Furthermore, upon receiving control data for the wired network 10, the session management unit 103 extracts, as identification information, a media access control (MAC) address, a virtual local area network-identifier (VLAN-ID), an Internet Protocol (IP) address, a protocol number, an L4 port number, and the like.

In addition, the session management unit 103 extracts, from the received control data, resource information allocated by the 5G core 39 to the wireless terminal 34. The session management unit 103 outputs the extracted identification information and resource information to the table control unit 102. As described above, the session management unit 103 extracts, from the control data received from the 5G core 39 connected to the OpenFlow switches 13 and 33, the identification information on the OpenFlow switches 13 and 33 and the resource information allocated by the 5G core 39 to the wireless terminal 34 to be connected to the OpenFlow switch 33 of the wireless network 30. Note that while it is described, in the present embodiment, that the session management unit 103 individually receives control data for the wireless network 30 and control data for the wired network 10, the session management unit 103 may receive control data including the respective pieces of information put together.

The table control unit 102 acquires the identification information and the resource information from the session management unit 103, and generates transfer operation information indicating details of transfer operation of communication data in the OpenFlow switches 13 and 33 by using the resource information. The transfer operation information is information indicating transfer operation of communication data in the OpenFlow switches 13 and 33. For example, the table control unit 102 generates the transfer operation information by using the QFI and the resource information. The table control unit 102, for example, registers identification information and transfer operation information in the flow-bearer conversion table 110, deletes identification information and transfer operation information from the flow-bearer conversion table 110, and changes identification information and transfer operation information in the flow-bearer conversion table 110. The table control unit 102 registers, in the flow-bearer conversion table 110, the identification information on the OpenFlow switches 13 and 33 extracted by the session management unit 103 and the transfer operation information based on the resource information in association with each other.

The flow-bearer conversion table 110 is a table in which the identification information on the OpenFlow switches 13 and 33 and the transfer operation information indicating details of transfer processing of communication data in the OpenFlow switches 13 and 33 are registered in association with each other. The flow-bearer conversion table 110 may be simply referred to as a table. A specific example of the flow-bearer conversion table 110 will be described later.

Next, the configurations and operation of the OpenFlow switches 13 and 33 will be described. FIG. 3 is a diagram illustrating an example configuration of the OpenFlow switches 13 and 33 according to the present embodiment. The OpenFlow switches 13 and 33 each include a table control unit 202, a MUXDEMUX 204, PHYs 205, an analysis unit 206, an action unit 207, a counter 208, and a flow table 210.

Each PHY 205 of the OpenFlow switch 13 is connected to the 5G core 39 belonging to the wireless network 30, the DataNetwork 11 belonging to the wired network 10, and the DataNetwork 1, and performs wired data communication. In the following description, wired data communication will be referred to as data communication (IP/L4), and communication data to be used in the wired data communication (IP/L4) will be referred to as communication data (IP/L4). In the data communication (IP/L4) and the communication data (IP/L4), IP stands for an IP address, and L4 stands for an L4 port number.

Each PHY 205 of the OpenFlow switch 33 is connected to the antennas 31 and 32, the camera 37, and the 5G core 39 belonging to the wireless network 30, and performs wireless data communication. In the following description, wireless data communication will be referred to as data communication (GTP-U), and communication data to be used in the wireless data communication (GTP-U) will be referred to as communication data (GTP-U). In the data communication (GTP-U) and the communication data (GTP-U), GTP-U is a protocol to be used in the data communication (GTP-U).

The MUXDEMUX 204 handles transfer of communication data in the direction of transmission and the direction of reception as viewed from the OpenFlow switches 13 and 33. Specifically, the MUXDEMUX 204 of the OpenFlow switch 13 transfers the communication data (IP/L4) from the action unit 207 to the PHY 205 at the time of transmission, and transfers the communication data (IP/L4) from the PHY 205 to the analysis unit 206 at the time of reception. Similarly, the MUXDEMUX 204 of the OpenFlow switch 33 transfers the communication data (GTP-U) from the action unit 207 to the PHY 205 at the time of transmission, and transfers the communication data (GTP-U) from the PHY 205 to the analysis unit 206 at the time of reception. The MUXDEMUX 204 and the PHYs 205 are collectively referred to as a communication unit 209.

The analysis unit 206 extracts identification information from the received communication data. Specifically, upon receiving the communication data (IP/L4), the analysis unit 206 of the OpenFlow switch 13 extracts IP/L4 information as identification information from the communication data (IP/L4). Upon receiving the communication data (GTP-U), the analysis unit 206 of the OpenFlow switch 33 extracts a QFI as identification information from the communication data (GTP-U). The analysis unit 206 outputs the extracted identification information to the table control unit 202. Note that, in the present embodiment, an IP address and an L4 port number are used as identification information on the communication data (IP/L4), but this is merely an example, and identification information is not limited thereto. For example, a protocol number or a MAC address may be used as identification information. In addition, the IP version may be IPv4 or IPv6.

The table control unit 202 acquires the identification information from the analysis unit 206, and performs a process of searching the flow table 210 on the basis of the identification information. In this manner, the table control unit 202 searches the flow table 210 on the basis of the identification information included in the communication data, and acquires transfer operation information corresponding to the identification information. The table control unit 202 acquires, from the flow table 210, transfer operation information used in the action unit 207, and outputs the transfer operation information as a search result to the analysis unit 206. The transfer operation information is information indicating a transfer destination, a maximum band, a minimum band, and the like in the case of transferring the communication data (IP/L4) or the communication data (GTP-U), and indicating discard processing in the case of not transferring the communication data (IP/L4) or the communication data (GTP-U).

The flow tables 210 are tables in which identification information on the OpenFlow switches 13 and 33 and transfer operation information indicating details of transfer processing of communication data in the OpenFlow switches 13 and 33 are registered in association with each other. The flow table 210 may be simply referred to as a table. A specific example of the flow table 210 will be described later.

The analysis unit 206 of the OpenFlow switch 13 outputs, to the action unit 207 and the counter 208, the communication data (IP/L4) and the transfer operation information acquired from the table control unit 202. The analysis unit 206 of the OpenFlow switch 33 outputs, to the action unit 207 and the counter 208, the communication data (GTP-U) and the transfer operation information acquired from the table control unit 202.

The counter 208 of the OpenFlow switch 13 performs counting processing by identifying the communication data (IP/L4) acquired from the analysis unit 206 for each statistical attribute on the basis of, for example, reception time, a frame length, an IP address, and an L4 port number. The counter 208 of the OpenFlow switch 33 performs counting processing by identifying the communication data (GTP-U) acquired from the analysis unit 206 for each statistical attribute on the basis of, for example, reception time, a frame length, and a QFI. The counter 208 notifies the action unit 207 of counting information obtained as a result of performing the counting processing.

The action unit 207 performs transfer processing of the communication data in accordance with the communication data (IP/L4) or the communication data (GTP-U) and the transfer operation information acquired from the analysis unit 206. When the transfer operation information is transfer processing, the action unit 207 coordinates the communication data and the transfer operation information with the counting information acquired from the counter 208. When the maximum band is exceeded, the action unit 207 discards corresponding communication data (IP/L4) or communication data (GTP-U). When the maximum band is not exceeded, the action unit 207 determines the PHY 205 that is a transmission destination, and transfers the corresponding communication data (IP/L4) or communication data (GTP-U) to the MUXDEMUX 204.

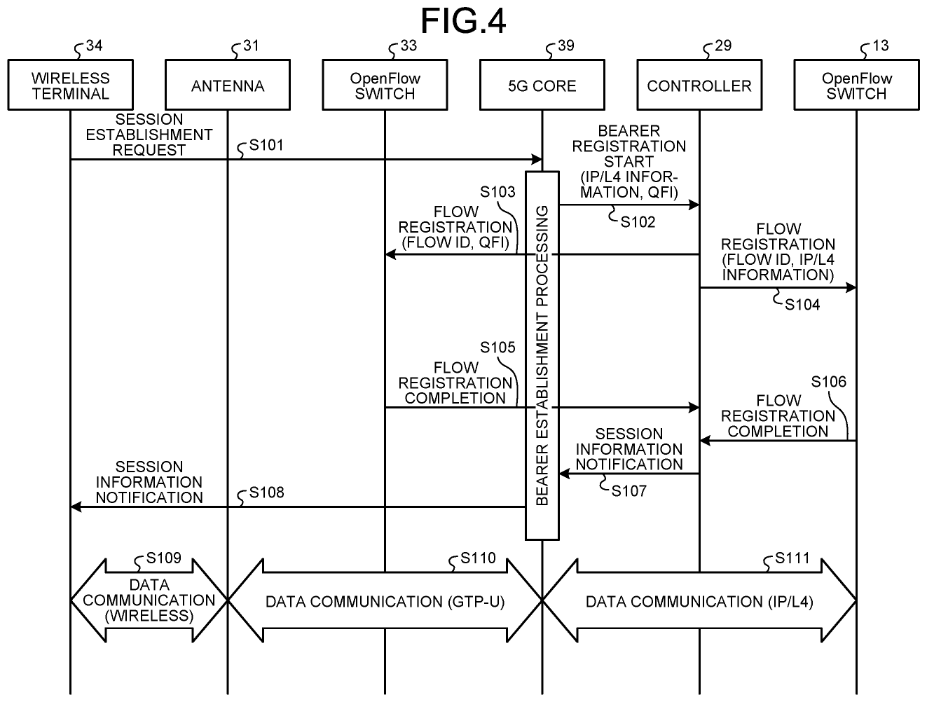

FIG. 4 is a sequence diagram illustrating a process in which the communication system 50 according to the present embodiment establishes communication with the wireless terminal 34. As illustrated in FIG. 4, first, the wireless terminal 34 issues a session establishment request to the 5G core 39 (step S101).

Upon acquiring the session establishment request from the wireless terminal 34, the 5G core 39 performs processing for establishing data communication (wireless) and data communication (GTP-U) between the wireless terminal 34 and the 5G core 39 in bearer establishment processing (steps S109 and S110). Specifically, the 5G core 39 notifies the controller 29 of a bearer registration start (IP/L4 information and QFI) (step S102). At this time, the 5G core 39 also notifies the controller 29 of resource information to be allocated to the wireless terminal 34.

Upon acquiring the bearer registration start (IP/L4 information and QFI), the controller 29 determines transfer operation information in view of the resource information, transmits flow registration (Flow ID and QFI) to the OpenFlow switch 33 (step S103), and transmits flow registration (Flow ID and IP/L4 information) to the OpenFlow switch 13 (step S104). The Flow ID is information indicating transfer operation information. When newly registering the transfer operation information based on the bearer registration start (IP/L4 information and QFI), the controller 29 transmits, to the OpenFlow switches 13 and 33, the flow registration including specific transfer operation information together with a Flow ID.

The OpenFlow switch 33 performs table registration for the flow table 210 by using the flow registration (Flow ID and QFI) acquired from the controller 29. When the table registration is completed, the OpenFlow switch 33 transmits flow registration completion to the controller 29 (step S105).

The OpenFlow switch 13 performs table registration for the flow table 210 by using the flow registration (Flow ID and IP/L4 information) acquired from the controller 29. When the table registration is completed, the OpenFlow switch 13 transmits flow registration completion to the controller 29 (step S106).

The controller 29 transmits session information notification to the 5G core 39 so as to provide a notification that the flow registration in the OpenFlow switches 13 and 33 has been completed (step S107).

Upon receiving the session information notification from the controller 29, the 5G core 39 transmits the session information notification to the wireless terminal 34 (step S108).

As a result of receiving the session information notification from the 5G core 39, the wireless terminal 34 can recognize that data communication (wireless) has been established (step S109), data communication (GTP-U) has been established (step S110), and data communication (IP/L4) has been established (step S111).

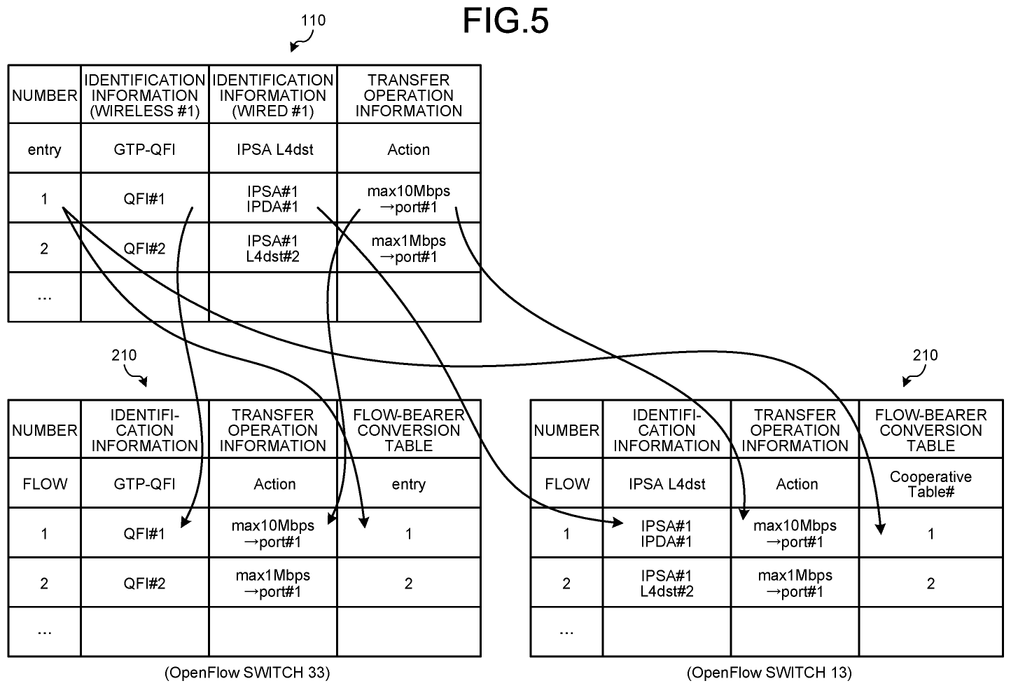

FIG. 5 is a diagram illustrating relationships between the flow-bearer conversion table 110 included in the controller 29 and the flow tables 210 included in the OpenFlow switches 13 and 33 according to the present embodiment. The controller 29 manages details of entries in the flow tables 210 of the OpenFlow switches 13 and 33 by using the flow-bearer conversion table 110. Identification information and transfer operation information regarding the OpenFlow switches 13 and 33 are registered in association with each other in the flow-bearer conversion table 110 of the controller 29. The controller 29 transmits, to the OpenFlow switch 13, the transfer operation information together with a Flow ID indicating an entry in the flow-bearer conversion table 110 corresponding to the identification information (wireless #1 in the example of FIG. 5) for the wireless network 30. In addition, the controller 29 transmits, to the OpenFlow switch 33, the transfer operation information together with a Flow ID indicating an entry in the flow-bearer conversion table 110 corresponding to the identification information (wired #1 in the example of FIG. 5) for the wired network 10.

Next, operation of each device in the communication system 50 will be described. As illustrated in FIG. 1, the OpenFlow switch 33 and the wireless terminal 34 are present on the wireless network 30. The antennas 31 and 32 and the camera 37 are connected to the OpenFlow switch 33. The wireless terminal 34 is connected to the antenna 31 through communication of the radio signal 36.

The wireless terminal 34 is connected to a server in the DataNetwork 11 of the wired network 10 or a server in the DataNetwork 1, and performs wireless communication with the antenna 31 via the radio signal 36 to receive a service. The wireless terminal 34 is connected to the 5G core 39 via the antenna 31 and the OpenFlow switch 33 during wireless communication. Bearer establishment processing is performed by the 5G core 39 for the wireless terminal 34. As a result, each of resources such as a band and a delay for the wireless terminal 34 is determined to establish a bearer, so that data communication becomes possible. Meanwhile, in the wireless network 30, the camera 37 transmits moving image data to a monitoring server in the DataNetwork 11 of the wired network 10 via the OpenFlow switch 33, the 5G core 39, and the OpenFlow switch 13.

Here, a conventional OpenFlow switch can identify only up to the protocol of Layer 4 such as TCP or UDP, and thus cannot identify data (QFI in Layer 5 GTP-U header) from the wireless terminal 34. It is difficult for the conventional OpenFlow switch to ensure resources for the wireless terminal 34. Therefore, there is a possibility that a conflict with moving image data from the camera 37 may occur when data from the wireless terminal 34 are transferred. In addition, in the conventional OpenFlow switch, resource information for data communication between the wireless terminal 34 and the 5G core 39 cannot be coordinated. Therefore, there is a possibility that ensured resources may be wasted and efficiency of network bandwidth may be impaired in the wired network 10.

In contrast, in the present embodiment, the communication system 50 ensures consistent network resources and enhances network efficiency in the local network by coordinating the identification information for the wireless network 30 and the wired network 10 with the resource information. In the present embodiment, the controller 29 is involved in the bearer establishment processing between the wireless terminal 34 and the 5G core 39 as illustrated in FIG. 4. In addition, the OpenFlow switch 33 existing in the wireless network 30 extends the OpenFlow standard, and has the function of identifying a QFI in the GTP-U header of Layer 5.

The controller 29 manages the flow table 210 of the OpenFlow switch 33 of the wireless network 30 and the flow table 210 of the OpenFlow switch 13 of the wired network 10. The controller 29 registers, in the flow-bearer conversion table 110, pair information of the identification information in the wireless network 30 and the wired network 10 and the ensured resource information on the basis of resource information such as a band allocated by the 5G core 39 and a delay in wireless communication of the wireless terminal 34. The controller 29 registers a flow entry in the flow tables 210 of the OpenFlow switches 13 and 33 on the basis of the flow-bearer conversion table 110 as illustrated in FIG. 5.

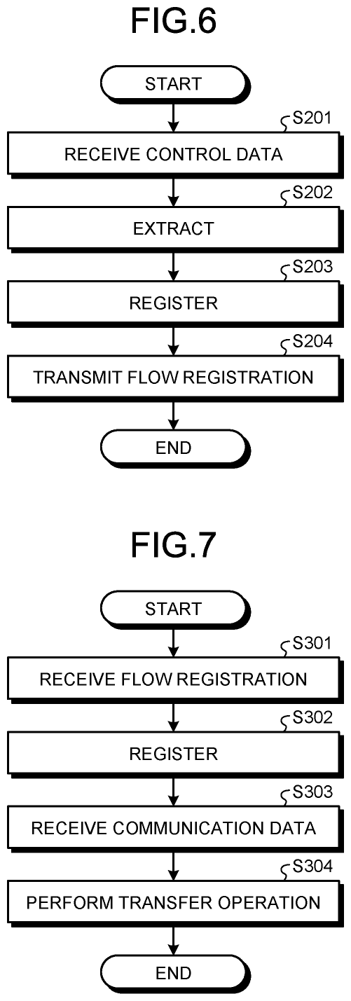

Operation of the controller 29 will be described with reference to a flowchart. FIG. 6 is a flowchart illustrating operation of the controller 29 according to the present embodiment. Upon receiving control data from the 5G core 39 (step S201), the controller 29 extracts identification information and resource information (step S202). The controller 29 registers the identification information in the flow-bearer conversion table 110 (step S203). When no transfer operation information corresponding to the identification information has been registered, the controller 29 also registers the transfer operation information in the flow-bearer conversion table 110 on the basis of the resource information. The controller 29 determines transfer operation information for the OpenFlow switches 13 and 33, transmits flow registration (Flow ID and QFI) to the OpenFlow switch 33, and transmits flow registration (Flow ID and IP/L4 information) to the OpenFlow switch 13 (step S204).

Operation of the OpenFlow switches 13 and 33 will be described with reference to a flowchart. Since the OpenFlow switches 13 and 33 are similar in operation, the OpenFlow switch 33 will be described as an example. FIG. 7 is a flowchart illustrating operation of the OpenFlow switch 33 according to the present embodiment. Upon receiving the flow registration (Flow ID and QFI) from the controller 29 (step S301), the OpenFlow switch 33 registers information on the flow registration (Flow ID and QFI) in the flow table 210 (step S302). Upon receiving the communication data (GTP-U) (step S303), the OpenFlow switch 33 performs transfer operation according to the flow table 210 (step S304). Note that the transfer operation includes a case of discarding the communication data (GTP-U).

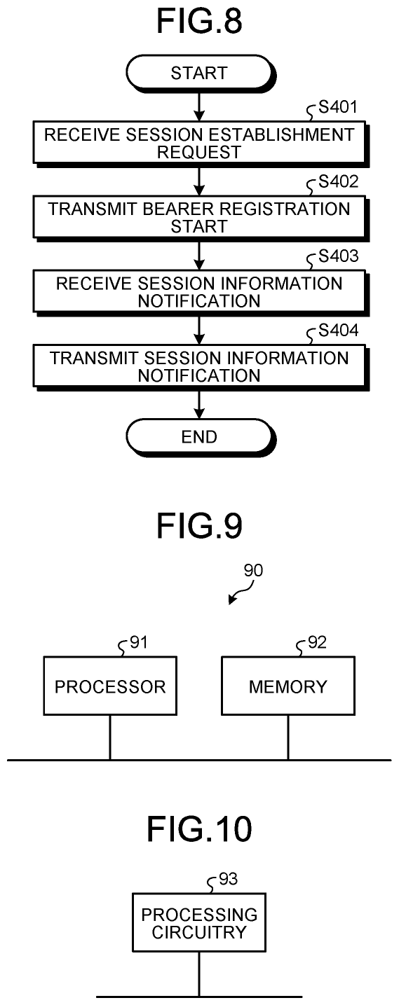

Operation of the 5G core 39 will be described with reference to a flowchart. FIG. 8 is a flowchart illustrating operation of the 5G Core 39 according to the present embodiment. Upon receiving a session establishment request from the wireless terminal 34 (step S401), the 5G core 39 transmits a bearer registration start (IP/L4 information and QFI) to the controller 29 (step S402). Upon receiving session information notification from the controller 29 (step S403), the 5G core 39 transmits the session information notification to the wireless terminal 34 (step S404).

Next, a hardware configuration of the controller 29 will be described. In the controller 29, the MUXDEMUX 104 and the PHY 105 are communication interfaces. The flow-bearer conversion table 110 is a memory. The table control unit 102 and the session management unit 103 are implemented by processing circuitry. The processing circuitry may be a memory and a processor that executes programs stored in the memory, or may be dedicated hardware. The processing circuitry is also referred to as a control circuit.

FIG. 9 is a diagram illustrating an example configuration of processing circuitry 90 in a case where processing circuitry included in the controller 29 according to the present embodiment is implemented by a processor and a memory. The processing circuitry 90 illustrated in FIG. 9 is a control circuit, and includes a processor 91 and a memory 92. In a case where the processing circuitry 90 includes the processor 91 and the memory 92, each function of the processing circuitry 90 is implemented by software, firmware, or a combination of software and firmware. The software or firmware is described as a program, and stored in the memory 92. The processor 91 reads and executes the program stored in the memory 92 to implement each function of the processing circuitry 90. That is, the processing circuitry 90 includes the memory 92 for storing a program that causes the processing of the controller 29 to be executed. It can also be said that this program is a program for causing the controller 29 to execute each function to be implemented by the processing circuitry 90. This program may be provided by a storage medium in which the program is stored, or may be provided by other means such as a communication medium.

It can also be said that the above-described program is a program for causing the controller 29 to perform: a first step of causing the session management unit 103 to extract, from control data received from the 5G core 39 connected to the OpenFlow switches 13 and 33, identification information on the OpenFlow switches 13 and 33 and resource information allocated by the 5G core 39 to the wireless terminal 34 to be connected to the OpenFlow switch 33 of the wireless network 30; and a second step of causing the table control unit 102 to register, in the flow-bearer conversion table 110, the identification information on the OpenFlow switches 13 and 33 extracted by the session management unit 103 and transfer operation information based on the resource information in association with each other.

Here, the processor 91 is, for example, a central processing unit (CPU), a processing device, an arithmetic device, a microprocessor, a microcomputer, or a digital signal processor (DSP). Furthermore, examples of the memory 92 include nonvolatile or volatile semiconductor memories such as a random access memory (RAM), a read only memory (ROM), a flash memory, an erasable programmable ROM (EPROM), and an electrically EPROM (EEPROM) (registered trademark), a magnetic disk, a flexible disk, an optical disk, a compact disk, a mini disk, and a digital versatile disc (DVD).

FIG. 10 is a diagram illustrating an example of processing circuitry 93 in a case where the processing circuitry included in the controller 29 according to the present embodiment includes dedicated hardware. For example, a single circuit, a composite circuit, a programmed processor, a parallel-programmed processor, an application specific integrated circuit (ASIC), a field-programmable gate array (FPGA), or a combination thereof is applicable to the processing circuitry 93 illustrated in FIG. 10. The processing circuitry may be partially implemented by dedicated hardware and partially implemented by software or firmware. Thus, the processing circuitry can implement each of the above-described functions by means of dedicated hardware, software, firmware, or a combination thereof.

The hardware configuration of the controller 29 has been described, and the same applies to the hardware configurations of the OpenFlow switches 13 and 33. In the OpenFlow switches 13 and 33, the MUXDEMUX 204 and the PHYs 205 are communication interfaces. The flow table 210 is a memory. The table control unit 202, the analysis unit 206, the action unit 207, and the counter 208 are implemented by processing circuitry. The processing circuitry may be a memory and a processor that executes programs stored in the memory, or may be dedicated hardware.

It can also be said that, in the OpenFlow switches 13 and 33, the above-described program is a program that causes the OpenFlow switches 13 and 33 to perform: a first step of causing the table control unit 202 to search the flow table 210 on the basis of identification information included in communication data, and acquire transfer operation information corresponding to the identification information; and a second step of causing the action unit 207 to perform transfer processing of the communication data according to the transfer operation information.

As described above, according to the present embodiment, the controller 29 in the communication system 50 controls the OpenFlow switches 13 and 33 with expanded identification capability by using identification information in a frame capable identifying a QoS in the wireless network 30 and the wired network 10. As a result, even when communication is performed across different networks such as the wireless network 30 and the wired network 10, the communication system 50 can flexibly ensure end-to-end QoS. The communication system 50 can achieve consistent QoS control between networks using different routing protocols.

A controller according to the present disclosure has the effect of enabling communication with ensured service quality in a communication system for a heterogeneous network including a wireless network and a wired network.

The configurations set forth in the above embodiment show examples, and it is possible to combine the configurations with another technique that is publicly known or combine the embodiment with each other, and is also possible to make omissions and changes to part of the configurations without departing from the scope of the present disclosure.

What is claimed is:

1. A controller to control transfer of communication data in a communication system including a wired network and a wireless network, the transfer of communication data being performed by a first communication apparatus included in each of the wired network and the wireless network, the controller comprising:
a table in which identification information on the first communication apparatus and transfer operation information are registered in association with each other, the transfer operation information indicating details of transfer processing of communication data in the first communication apparatus;
session management circuitry to extract the identification information on the first communication apparatus and resource information from control data received from a second communication apparatus connected to the first communication apparatus, the resource information being allocated by the second communication apparatus to a wireless terminal to be connected to the first communication apparatus of the wireless network; and
table control circuitry to register, in the table, the identification information on the first communication apparatus and the transfer operation information in association with each other, the identification information on the first communication apparatus being extracted by the session management circuitry, the transfer operation information being based on the resource information.

2. The controller according to claim 1, comprising:
communication circuitry to receive the control data from the second communication apparatus, and transmit the transfer operation information to the first communication apparatus via the second communication apparatus, the transfer operation information being obtained by the table control circuitry.

3. The controller according to claim 1, wherein
a QFI is used as the identification information on the first communication apparatus included in the wireless network, the QFI being a Quality of Service Flow Identifier regarding service quality, the QFI being contained in a header of a frame to be used for data transfer to be performed by use of GTP-U that is a General Packet Radio Service Tunneling Protocol for User Plane.

4. The controller according to claim 2, wherein
a QFI is used as the identification information on the first communication apparatus included in the wireless network, the QFI being a Quality of Service Flow Identifier regarding service quality, the QFI being contained in a header of a frame to be used for data transfer to be performed by use of GTP-U that is a General Packet Radio Service Tunneling Protocol for User Plane.

5. The controller according to claim 3, wherein
the table control circuitry generates the transfer operation information by using the QFI and the resource information, and registers the generated transfer operation information in the table.

6. The controller according to claim 4, wherein
the table control circuitry generates the transfer operation information by using the QFI and the resource information, and registers the generated transfer operation information in the table.

7. A communication apparatus included in each of a wired network and a wireless network in a communication system including the wired network and the wireless network, the communication apparatus comprising:
a table in which identification information on the communication apparatus and transfer operation information are registered in association with each other, the transfer operation information indicating details of transfer processing of communication data in the communication apparatus;
table control circuitry to search the table based on the identification information included in the communication data, and acquire the transfer operation information corresponding to the identification information; and
action circuitry to perform transfer processing of the communication data according to the transfer operation information.

8. The communication apparatus according to claim 7, wherein
a QFI is used as the identification information on the communication apparatus included in the wireless network, the QFI being a Quality of Service Flow Identifier regarding service quality, the QFI being contained in a header of a frame to be used for data transfer to be performed by use of GTP-U that is a General Packet Radio Service Tunneling Protocol for User Plane.

9. A communication system comprising:
a controller to control transfer of communication data in a communication system including a wired network and a wireless network, the transfer of communication data being performed by a first communication apparatus included in each of the wired network and the wireless network, the controller comprising
a table in which identification information on the first communication apparatus and transfer operation information are registered in association with each other, the transfer operation information indicating details of transfer processing of communication data in the first communication apparatus,
session management circuitry to extract the identification information on the first communication apparatus and resource information from control data received from a second communication apparatus connected to the first communication apparatus, the resource information being allocated by the second communication apparatus to a wireless terminal to be connected to the first communication apparatus of the wireless network, and
table control circuitry to register, in the table, the identification information on the first communication apparatus and the transfer operation information in association with each other, the identification information on the first communication apparatus being extracted by the session management circuitry, the transfer operation information being based on the resource information; and
the communication apparatus according to claim 7.

10. A communication system comprising:
a controller to control transfer of communication data in a communication system including a wired network and a wireless network, the transfer of communication data being performed by a first communication apparatus included in each of the wired network and the wireless network, the controller comprising
a table in which identification information on the first communication apparatus and transfer operation information are registered in association with each other, the transfer operation information indicating details of transfer processing of communication data in the first communication apparatus,
session management circuitry to extract the identification information on the first communication apparatus and resource information from control data received from a second communication apparatus connected to the first communication apparatus, the resource information being allocated by the second communication apparatus to a wireless terminal to be connected to the first communication apparatus of the wireless network, and
table control circuitry to register, in the table, the identification information on the first communication apparatus and the transfer operation information in association with each other, the identification information on the first communication apparatus being extracted by the session management circuitry, the transfer operation information being based on the resource information; and
the communication apparatus according to claim 8, wherein
a QFI is used as the identification information on the first communication apparatus included in the wireless network, the QFI being a Quality of Service Flow Identifier regarding service quality, the QFI being contained in a header of a frame to be used for data transfer to be performed by use of GTP-U that is a General Packet Radio Service Tunneling Protocol for User Plane.

11. A control circuit to control a controller, the controller controlling transfer of communication data in a communication system including a wired network and a wireless network, the transfer of communication data being performed by a first communication apparatus included in each of the wired network and the wireless network, the control circuit comprising:
a table in which identification information on the first communication apparatus and transfer operation information are registered in association with each other, the transfer operation information indicating details of transfer processing of communication data in the first communication apparatus, wherein
the control circuit causes the controller to:
extract the identification information on the first communication apparatus and resource information from control data received from a second communication apparatus connected to the first communication apparatus, the resource information being allocated by the second communication apparatus to a wireless terminal to be connected to the first communication apparatus of the wireless network; and
register, in the table, the identification information on the first communication apparatus and the transfer operation information in association with each other, the transfer operation information being based on the resource information.

12. A control circuit to control a communication apparatus included in each of a wired network and a wireless network in a communication system including the wired network and the wireless network, the control circuit comprising:
a table in which identification information on the communication apparatus and transfer operation information are registered in association with each other, the transfer operation information indicating details of transfer processing of communication data in the communication apparatus, wherein
the control circuit causes the communication apparatus to:
search the table based on the identification information included in the communication data, and acquire the transfer operation information corresponding to the identification information; and
perform transfer processing of the communication data according to the transfer operation information.

13. A non-transitory storage medium having stored thereon a program for controlling a controller, the controller controlling transfer of communication data in a communication system including a wired network and a wireless network, the transfer of communication data being performed by a first communication apparatus included in each of the wired network and the wireless network, wherein
the controller includes a table in which identification information on the first communication apparatus and transfer operation information are registered in association with each other, the transfer operation information indicating details of transfer processing of communication data in the first communication apparatus, and
the program causes the controller to:
extract the identification information on the first communication apparatus and resource information from control data received from a second communication apparatus connected to the first communication apparatus, the resource information being allocated by the second communication apparatus to a wireless terminal to be connected to the first communication apparatus of the wireless network; and
register, in the table, the identification information on the first communication apparatus and the transfer operation information in association with each other, the transfer operation information being based on the resource information.

14. A non-transitory storage medium having stored thereon a program for controlling a communication apparatus included in each of a wired network and a wireless network in a communication system including the wired network and the wireless network, wherein
the communication apparatus includes
a table in which identification information on the communication apparatus and transfer operation information are registered in association with each other, the transfer operation information indicating details of transfer processing of communication data in the communication apparatus, and
the program causes the communication apparatus to:
search the table based on the identification information included in the communication data, and acquire the transfer operation information corresponding to the identification information; and
perform transfer processing of the communication data according to the transfer operation information.

15. A communication method for a controller to control transfer of communication data in a communication system including a wired network and a wireless network, the transfer of communication data being performed by a first communication apparatus included in each of the wired network and the wireless network, wherein
the controller includes a table in which identification information on the first communication apparatus and transfer operation information are registered in association with each other, the transfer operation information indicating details of transfer processing of communication data in the first communication apparatus, and
the method comprises:
extracting the identification information on the first communication apparatus and resource information from control data received from a second communication apparatus connected to the first communication apparatus, the resource information being allocated by the second communication apparatus to a wireless terminal to be connected to the first communication apparatus of the wireless network; and
registering, in the table, the identification information on the first communication apparatus and the transfer operation information in association with each other, the identification information on the first communication apparatus being extracted in the extracting, the transfer operation information being based on the resource information.

16. A communication method for a communication apparatus included in each of a wired network and a wireless network in a communication system including the wired network and the wireless network, wherein
the communication apparatus includes a table in which identification information on the communication apparatus and transfer operation information are registered in association with each other, the transfer operation information indicating details of transfer processing of communication data in the communication apparatus, and
the method comprises:
searching the table based on the identification information included in the communication data, and acquiring the transfer operation information corresponding to the identification information; and
performing transfer processing of the communication data according to the transfer operation information.
